(19) United States
(12) Patent Application Publication
(10) Pub. No.: US 2004/0225751 A1
(43) Pub. Date: Nov. 11, 2004

(54) Systems and methods to facilitate e-business transactions through distributed systems

(76) Inventor: Prem S. Urali, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/424,117

(22) Filed: Apr. 25, 2003

(51) Int. Cl. G06F 15/16

(52) U.S. Cl. 709/246

(57) ABSTRACT

The present invention provides systems and methods to construct and transmit a run ticket(s) to facilitate a business transaction(s) within an e-business environment. Generally, a run ticket comprises business input (e.g., a purchase order) that has been translated into a suitable representation (e.g., XML-based) and bound to associated information (e.g., configuration data, processing rule(s), instruction(s) and/or action(s)). The run ticket typically includes routing information to form a self-routing envelope. In addition, information such as user ID, password and a security mechanism (e.g., shared secret), for example, can be included to facilitate access and delivery of the run ticket. The systems and methods include components to translate input, to provide associated information, to encapsulate translated input with associated information to form a run ticket, and to receive and/or transmit the run ticket. The systems and methods mitigate hard coding configuration, reduce overhead, increase flexibility, and facilitate transmission through software layers across distributed systems.

### TECHNICAL FIELD

The present invention generally relates to facilitating e-business transaction routing, and in particular to systems and methods to facilitate transmission of business information through software layers across distributed systems.

### BACKGROUND OF THE INVENTION

Electronic commerce (e.g., e-commerce and e-business) has evolutionalized business practices by providing an efficient, reliable and cost-effective medium for business transactions. This evolution has fueled a growing trend towards eliminating paper transactions and conducting a large volume of business electronically. Many businesses have already shifted paradigms and are conducting a substantial portion of their business via networks (e.g., the Internet, virtual private networks and/or an intranets).

One advantage of conducting e-business is that it provides a business with a capability to efficiently transmit and receive information from essentially anywhere and at any time. The impact of such accessibility has provided business relationships with markets that were once unavailable, world-wide visibility, increased competition within markets, quality improvements, “true” market driven prices, increased buyer/seller choice, decreased operational costs through mitigating overhead such as paper products, and diminished paper waste.

The robustness of e-business continues to progress with technological advances in the electrical/electronical and software fields. Such advances provide improved communication devices and improved user-friendly applications. In addition, the availability and affordability of computerized systems and e-business software that can be executed thereon facilitates a growing movement towards selling and purchasing goods via e-business. From the foregoing advances and trends, it has become foreseeable that the near future will demand business transactions to be conducted via e-business in order to compete within a business market.

A simple example of an e-business transaction includes a business-to-business purchase of goods. For example, a seller and a buyer can interface via a network (e.g., the Internet), wherein the seller can provide product information, including price. The buyer can submit an order to the seller for a quantity of goods as an e-business transaction. For example, the buyer can submit a purchase order via an e-business transaction instead of the conventional means of mailing a paper form. When the seller receives the e-business purchase order, the seller can process the order and reply with an e-business invoice.

In many e-business instances, information is transmitted to a plurality of parties, wherein one or more of the parities can reside on a similar network and/or be distributed amongst networks. By way of example, a company can order parts, via an e-business transaction, that are employed to construct a product that the company sells. After the parts arrive, the Receiving Department can update its computerized records to confirm that the parts were delivered, to archive the deliverer's identification, and to denote the condition of the package. The Receiving Department can then transmit the confirmation and/or other information to local and remote departments to notify them that the parts have arrived. For example, the Sales Department can then update its internal price book to reflect the quantity of parts, the Manufacturing Department can then internally purchase parts to construct products, the R&D Department can then lease parts for non-destructive experimentation, and the Accounts Payable Department can then be apprised that the payment period has commenced.

Typical information transmitted in an e-business transaction can include, for example, a set of business data and associated actions. For example, confirmation and/or other information from the above example that was transmitted from Receiving Department can include the invoice, the confirmation record, the deliverer's identification, and the package condition. However, such information can comprise a plurality of items that is to be conveyed through different layers of software across distributed systems utilizing various communication and security protocols. The current state of e-business affords a problematic means to maintain the foregoing processing rules for the information as the information flows from one layer of software to another layer within the distributed system.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

The present invention provides systems and methods to package business related information with associated configuration into a self-routing unit, referred to as a run ticket that can be transmitted as an e-business transaction. The run ticket can be employed by a business to convey information, such as a purchase order for example, and associated configuration to another business party(s). For example, a business can package the purchase order with information related to but separate from (e.g., a different document or media) the purchase order. Thus, a business can assemble a run ticket to encapsulate a plurality of associated information, and transmit the run ticket to another business(s) via an e-business transaction to convey the information to the other business(s).

For example, the run ticket can be an XML-based envelope. However, other markup language, standard formats and known techniques can be employed. The envelope generally includes a representation (e.g., XML-based) of the input being transmitted (e.g., a purchase order) bound to associated information such as routing information, a user ID, a password, and/or a security mechanism (e.g., a shared secret). However, other information including configuration, instruction(s) and/or action(s), for example, can be employed. The associated information is generally obtained from a central storage facility (e.g., a database), and can be included within an XML-based header that can be delineated within field(s) such as application and/or configuration field(s), for example.

The systems and methods can be employed amongst business parties. Thus, a business party can provide an input, and the system and methods can be employed to construct and transmit a run ticket that encapsulates the input with associated information obtained from the central storage facility. The systems and methods can then be employed to transmit the run ticket. As noted above, the run ticket can include routing information, a user ID, a password, and a shared secret. The transmitting mechanism can access the routing information to determine the receiving party(s). Additionally, the user ID, the password and/or the shared secret can be obtained to facilitate the interface with the receiving party(s).

The systems and methods of the present invention mitigate hard coding substantially all routing information via binding the routing information to the input representation in the run ticket. Furthermore, the systems and methods mitigate maintaining a plurality of storage locations for associated information and reduce the corresponding overhead via providing a central storage location for the associated information. Providing the central storage location additionally increases system flexibility via providing a dynamic medium wherein associated information can be added, modified and/or deleted, and refreshed without affecting (e.g., re-booting) a business party. Moreover, the run ticket provides a self-routing unit with security information. Thus the present invention facilitates transmitting information through various software layers and/or across distributed systems.

In one aspect of the present invention, an information packaging and delivery system is provided to construct and transmit run ticket(s). An external business party can employ the system to transmit information to an internal business application (IBA) and/or order management system (OMS), for example. The system includes a translation component to convert an input into a suitable representation. Typically, the translation component accepts an input, and converts the input into an XML-based representation. The system further includes an encapsulating component to bind the XML-based representation with configuration information obtained from an instructions bank to form the run ticket. The instructions bank provides a central storage area that can be dynamically modified, and typically includes configuration information such as routing information, a user ID, and/or a password. After assembling the run ticket, a dispatch component can be employed to transmit the run ticket.

In another aspect of the present invention, an input delivery system is provided to construct and transmit a run ticket. An IBA and/or OMS can utilize the system to transmit information to an external party(s), for example. The system includes an input component coupled to a binding component, wherein the input component accepts input and conveys the input to the binding component. Then, the binding component translates the input (e.g., into cXML), and constructs a run ticket that includes the translated input and associated instructions from a rules bank. The run ticket is accessible to external parties, and the external parties can extract and employ the input and/or associated instructions within the run ticket.

The present invention can be employed in various environments including bi-directional communication environments wherein run tickets can be received and/or constructed and transmitted via a plurality of components, and across distributed systems wherein components can reside within different networks, intranets and/or machines. Furthermore, a run ticket can encapsulate various configuration information, employ suitable schemas, and/or provide for batching input.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a block diagram of a system that facilitates distributed processing associated with a plurality of system in connection with an item in accordance with an aspect of the present invention.

FIG. 2 is a block diagram of an information packaging and delivery system in accordance with an aspect of the present invention.

FIG. 3 is a block diagram of a system for processing item(s) in accordance with an aspect of the present invention.

FIG. 4 is a diagram of an exemplary run ticket header in accordance with an aspect of the present invention.

FIG. 5 is a diagram of exemplary run ticket XML-based pseudo code in accordance with an aspect of the present invention.

FIG. 6 is a block diagram of a batch interpreter system in accordance with an aspect of the present invention.

FIG. 7 is a block diagram of a system employing run ticket(s) in accordance with an aspect of the present invention.

FIG. 8 is a flow chart of a method of constructing a run ticket in accordance with an aspect of the present invention.

FIG. 9 is a flow chart of a method to construct and employ a run ticket in accordance with an aspect of the present invention.

FIG. 10 is a flow chart of a method of utilizing a run ticket in accordance with an aspect of the present invention.

FIG. 11 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident to one skilled in the art that the present invention may be practiced without these specific details. In other instances, well-known structures and devices are shown in block diagram form in order to facilitate description of the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component.

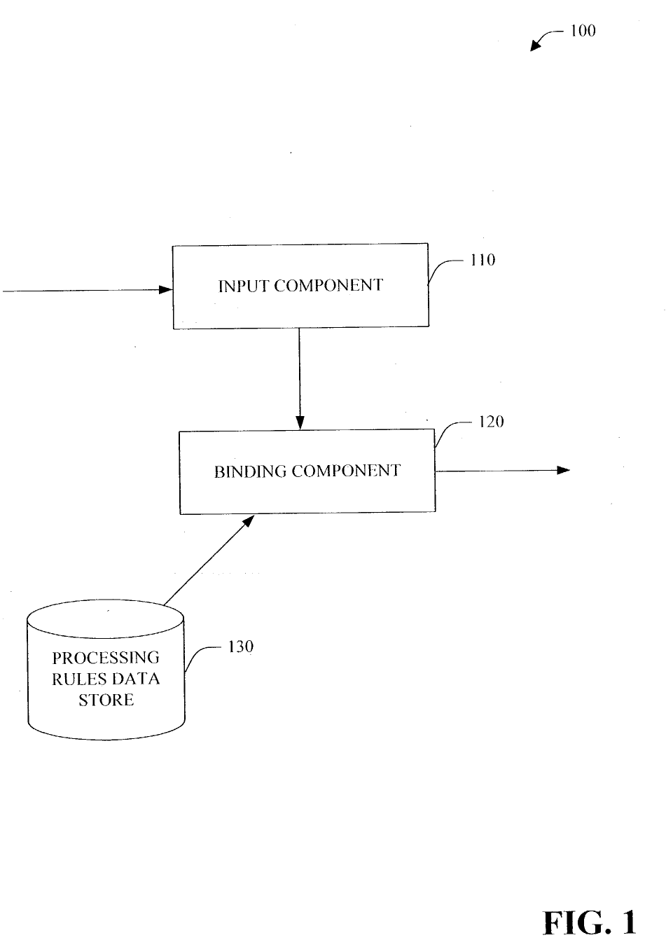

Referring to FIG. 1, a system that facilitates distributed processing associated with a plurality of system in connection with an item 100 in accordance with an aspect of the present invention is illustrated. The system 100 includes an input component 110 and a binding component 120. Optionally, the system 100 can include a processing rules data store 130. The system 100 can facilitate binding of information and/or associated configuration information into a self-routing unit (e.g., XML-based envelope), sometimes referred to herein as a “run ticket”. For example, a run ticket can be transmitted as part of (e.g., purchase order, invoice etc. ) and a run ticket. The run ticket call be used by an integration engine (not shown), a business process (not shown) and/or an application adapter (not shown) to route and/or access the document.

The input component 110 can receive an input, for example a document such as a purchase order, an invoice and/or a word processing document. In one example, the input component 110 can then employ transformation logic to convert the input to a schema and/or representation that can employed by the binding component 120. For example, the input component 110 can employ technique(s) to convert the input to a markup language (e.g., XML, cXML, HTML, XHTML, and DAML) representation of the input. The conversion can be employed to render a representation of some and/or substantially all of the input.

While the system 100 is generally described herein in the context of a business-to-business electronic transaction, those skilled in the art will recognize that the present invention is not so limited. Thus, it is to be appreciated that various other input(s) can be accepted and/or converted in accordance with an aspect of the invention. For example, video, audio (e.g., analog, digital and/or optical), and combinations thereof can be received and/or converted. In addition, input such as spreadsheets, responses, binary files, still images (e.g., jpeg, bitmap, tiff, gif, cgm and emf), sound (e.g., MSV and MP3), digital moving images (e.g., mpeg and AVI), facsimile, email, satellite signals, and/or encrypted, encoded, compressed, and/or symbolic information can be accepted and/or converted.

The input component 110 provides the input (e.g., transformed) to the binding component 120, which binds (e.g., annotates) the input with associated information (e.g., configuration information, processing rule(s), instruction(s) and/or action(s)). The associated information can be based, at least in part, upon information received from the processing rules data store 130. For example, the binding component 120 can obtain routing information from the processing rules data store 130 and generate a run ticket that associates the routing information and the input. Furthermore, the binding component 120 can bind input (e.g., transformed) and associated information for more than one input, as described in detail below.

In one example, the binding component 120 can form a run ticket (e.g., an XML-based file) that includes transformed input, which can also be XML-based as noted above, and the associated information. The associated information can be represented in a header and/or other suitable manner in the run ticket, for example. Thus, the run ticket provides a technique for encapsulating the transformed input and the associated information in an envelope that can be transmitted to other components, wherein the contents of the envelope (e.g., the transformed input and associated information) can be extracted and utilized.

The processing rules data store 130 can be a central storage area (e.g., a database) that can be employed to store information associated with input. As noted above, the binding component 120 can access processing rules data store 130. For example, after receiving the input (e.g., transformed), the binding component 120 can access the processing rules data store 130 to obtain information to bind to the input to create the run ticket. The processing rules data store 130 can include various information, for example, metadata (e.g., shared secret) and/or processing rule(s).

By storing this information in the processing rules data store 130, hard coding or routing information and/or maintaining information for a plurality of banks corresponding to individual receiving components is mitigated. In addition, the overhead associated with maintaining the plurality of banks is reduced. Moreover, the processing rules data store 130 affords increased flexibility as the information stored therein can be dynamically modified and/or refreshed.

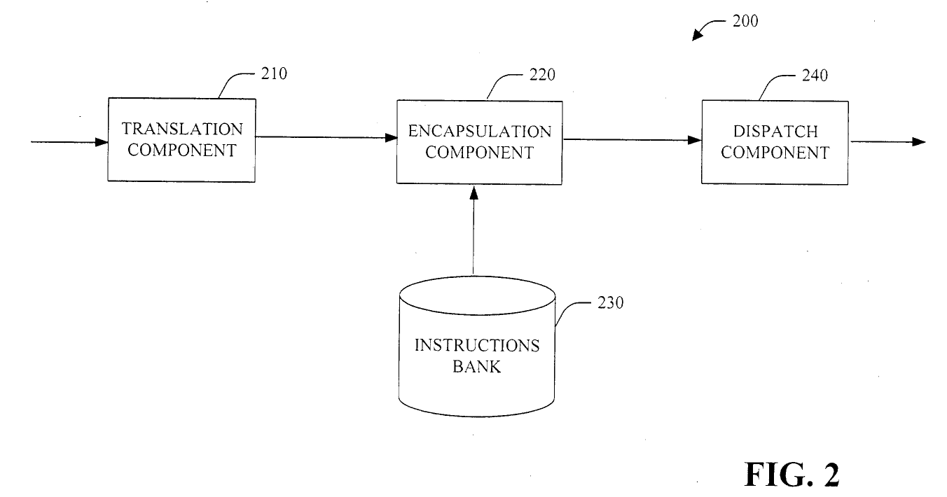

Turning to FIG. 2, an information packaging and delivery system 200 in accordance with an aspect of the present invention is illustrated. The information packaging and delivery system 200 includes a translation component 210 to convert an input into a suitable representation, an encapsulation component 220 to bind the representation with configuration information, an instructions bank 230 to store the configuration information for binding, and a dispatch component 240 to route the bound representation and configuration information (e.g., run ticket).

The translation component 210 can accept and convert input. For example, the translation component 210 can receive a document, such as a purchase order, an invoice and/or a word processing document. The translation component 210 can then employ transformation logic to convert the input to various schema(s) and/or representation(s) that can be accepted and utilized by the encapsulation component 220. For example, the translation component 210 can employ technique(s) to convert the input to a markup language (e.g., XML, cXML, HTML, XHTML, and DAML) representation of the input. The conversion can be employed to render a representation of some and/or substantially all of the input. The input can include, for example, video and/or audio (e.g., analog, digital and/or optical), spreadsheets, responses, binary files, still images (e.g., jpeg, bitmap, tiff, gif, cgm and emf), sound (e.g., MSV and MP3), digital moving images (e.g., mpeg and AVI), facsimile, email, satellite signals, and encrypted, encoded, compressed, and/or symbolic information.

The translation component 210 can transmit the converted input to the encapsulation component 220. The encapsulation component 220 can bind the transformed input that it obtains from the translation component 210 with associated information (e.g., configuration data, processing rule(s), instruction(s) and/or action(s)) that it obtains from the instructions bank 230. For example, the encapsulation component 220 can obtain routing information and/or other information (as described in detail below) from the instructions bank 230, and form an association between the information and the transformed input. Furthermore, the encapsulation component 220 can bind transformed input and associated information for more than one input, as described in detail below.

In one aspect of the present invention, the encapsulation component 220 can form a run ticket (e.g., an XML-based file) that includes the transformed input, which can also be XML-based as noted above, and the associated information. The associated information can be represented in a header, as described in detail below, and/or other suitable manner in the run ticket, for example. Thus, the run ticket provides a technique for encapsulating the transformed input and the associated information in an envelope that can be transmitted to other components, wherein the contents of the envelope (the transformed input and associated information) can be extracted and utilized. The run ticket can include, for example, routing information, processing rule(s), a user identification (ID), and/or a password.

After forming a run ticket, the encapsulation component 220 can provide the run ticket to the dispatch component 240. As noted above, various technique(s) can be employed to convey information through the system 200. For example, in one aspect of the present invention the encapsulation component 220 can transmit the run ticket to the dispatch component 240. In another aspect of the present invention, the encapsulation component 220 can broadcast a message to the dispatch component 240 to notify the dispatch component 240 that a run ticket is available. Then, either the encapsulation component 220 can convey the run ticket and/or the dispatch component 240 can retrieve the run ticket. In yet another aspect of the present invention, the encapsulation component 220 can transmit the run ticket and/or a pointing mechanism that identifies the location of the run ticket in an intermediate location such as a queue, a table, a database, a heap, a stack, and/or a register. The dispatch component 240 can then retrieve the run ticket via the intermediate location and/or from the location pointed to by the pointing mechanism.

The dispatch component 240 can access the information within the run ticket. The dispatch component 240 can read, extract and/or include additional information in the run ticket, such as dispatching component identification and other dispatching information, for example. However, the dispatch component 240 typically accesses the information to ascertain routing information, for example, to facilitate run ticket transmission. For example, the dispatch component 240 can read the routing information which can indicate that the run ticket should be transmitted to components “X,” “Y,” and “Z.” Then, the dispatch component 240 can transmit the run ticket to the components “X,” “Y,” and “Z.” For example, the dispatch component 240 can be part of an integration engine (not shown), application adapter (not shown) and/or business process (not shown).

It is to be appreciated that the encapsulation component 220 can, optionally, include mechanism(s) that can perform error checking to verify that the transformed input and/or the configuration information has not been corrupted. For example, if the transformed input is corrupt, the encapsulation component 220 can reject the transformed input, provide an error message and/or attempt to analyze and fix the problem. In one aspect of the invention, the translation component 210 can save a copy of the input and the transformed input. If the encapsulation component 220 determines that the received transformed input is corrupt, the translation component 210 can re-submit a copy of the saved transformed input and/or re-transform the input and subsequently transmit the newly transformed input. In addition, any error message provided by the encapsulation component 220 can be conveyed to the input provider. Furthermore, the encapsulation component 220 can halt binding the transformed input and the associated information, and provide an error message and/or attempt to resolve the problem.

The instructions bank 230 stores associated information which can be used to form the run ticket (e.g., processing rule(s)). Thus, the system 200 mitigates hard coding of routing information. Conventionally, routing information has hard coded such that the routing information can be retrieved via an application adapter for transmission of the input. Typically, routing information of substantially all possible input(s) is hard coded. Otherwise, the application adapter may not be able to deliver the input. Storing routing information in the instructions bank 230 allows a run ticket to be constructed with the associated routing information stored in the instructions bank 230. The dispatch component 240 can access the routing information from the run ticket instead of employing hard coded routing information. Thus, the run ticket can provide a self-routing unit of information.

Providing the instructions bank 230 and forming the run ticket with the associated information further mitigates maintaining a plurality of storage banks for individual components (e.g., application adapters), which reduces system overhead. For example, associated information can be collectively stored in the instructions bank 230 instead of storing associated information in individual storage banks corresponding to receiving components (e g., application adapters). Then, the associated information can be included in the run ticket such that the receiving component can access the run ticket for the associated information instead of retrieving the associated information from a corresponding storage bank. In addition, providing a dynamic instructions bank 230 increases system flexibility by providing a storage bank wherein the associated information can be dynamically modified and refreshed for concurrent and/or subsequent employment.

In accordance with an aspect of the present invention, the system 200 can be employed in an Internet and/or network environment. For example, the system 200 can be employed in a web server, a web service, an integration engine, and/or across distributed systems. Providing the foregoing affords for maintaining associated information (e.g., processing rule(s), configuration data, instruction(s) and/or action(s)) through various software layers and/or across distributed systems. For example, the system 200 can be employed in an e-business environment wherein business party(ies) (e.g., an external trading party) can employ the systems 200 to transmit run ticket(s) to other business party(ies) (e.g., an internal business application and order management system) to convey input and associated information.

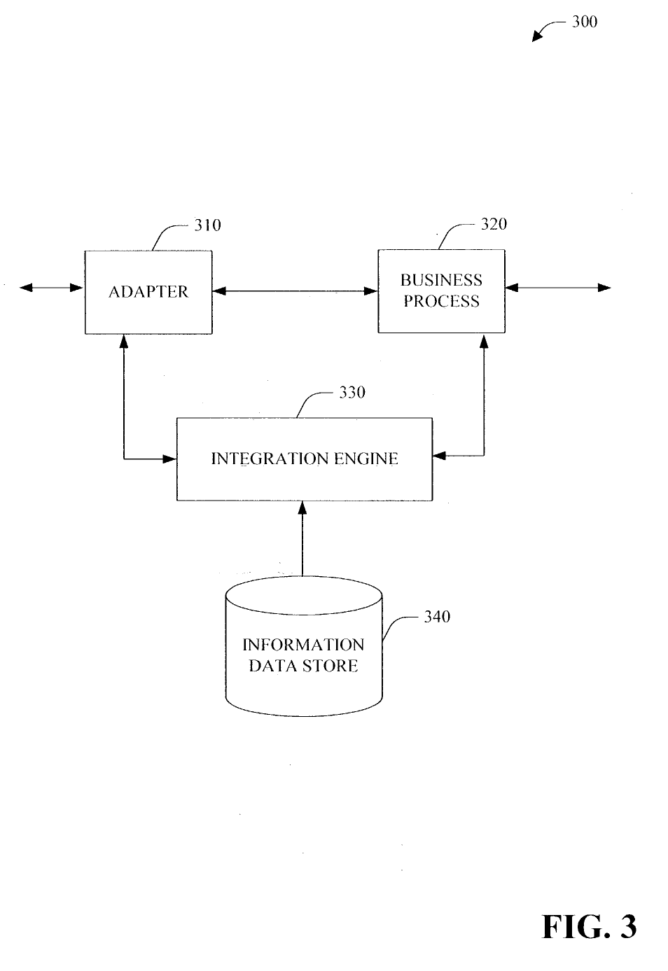

Next, turning to FIG. 3, a system 300 for processing item(s) in accordance with an aspect of the present invention is illustrated. The system 300 includes an adapter 310, a business process 320, an integration engine 330 and an information data store 340.

The information data store 340 (e.g., processing rules data store 130 and/or and rules bank 230) provides a dynamic central storage location for information associated with item(s) conveyed from components (e.g., external and internal). Employing a common storage unit, as noted supra, can mitigate hard coding routing information, maintaining a plurality of information banks, reduce the overhead associated with maintaining the plurality of banks, and/or increase system flexibility. For example, the system 300 can be employed to construct a run ticket, or self-routing unit, to transmit an item and associated information through various network configurations (e.g., software layer(s)). The run ticket can include routing information to mitigate providing and retrieving hard coded routing information and associated information (e.g., processing rule(s), user ID, password, shared secret and/or other configuration data), to mitigate maintaining configuration for components within individual storage banks.

The information data store 340 can be dynamic. For example, in one aspect of the present invention, information can be added, modified and/or deleted from the information data store 340 without affecting (e.g., re-booting) the integration engine 330, the business process 320, and/or the adapter 310. That is information can be added concurrently with accessing the information data store 340.

The information stored in the information data store 340 can be accessed via the integration engine 330. For example, after receiving an item from an external and/or internal component (e.g., the adapter 310 and/or the business process 320), the integration engine 330 can be employed to obtain associated information from the information data store 340 to bind with the received item in a run ticket.

In one aspect of the present invention, an external component can provide an item to the system 300. The business process 320 can facilitate translating the item into a suitable representation (e.g., markup language based). The business process 320 can then invoke the integration engine 330 which then accesses the information data store 340. Associated information can be obtained from the information data store 340 and utilized to construct a run ticket. For example, the associated information can be included in a header (e.g., as described below) in an XML envelope that further includes the translated item. The run ticket can then be provided to the adapter 310, which can interface with a plurality of internal components. The adapter 310 can access the run ticket information to determine routing information, user ID and/or password to access the item and/or internal component(s).

In another aspect of the present invention, an internal component provides an item (e.g., an acknowledgment, a status update, a ship notification and/or a payment transaction) to the system 300. The adapter 310 (e.g., the dispatch component 240) can receive and convey the item to the business process 320. The business process 320 can facilitate processing and transmitting the item. For example, the internal and the external components can employ a secure communication such as cXML (e.g., commerce XML) and/or other techniques for secure transactions (e.g., over the Internet). The business process 320 can facilitate translating the item to a suitable representation (e.g., XML-based) and access the integration engine 330 to facilitate binding the representation with security and/or other associated information.

The integration engine 330 can access the information data store 340 to obtain security and/or other information. After obtaining the security and/or other information, the integration engine 330 can encapsulate the item and the associated information within a run ticket. The integration engine 330 can provide the run ticket to the business process 320 which can then transmit the run ticket to the external component(s).

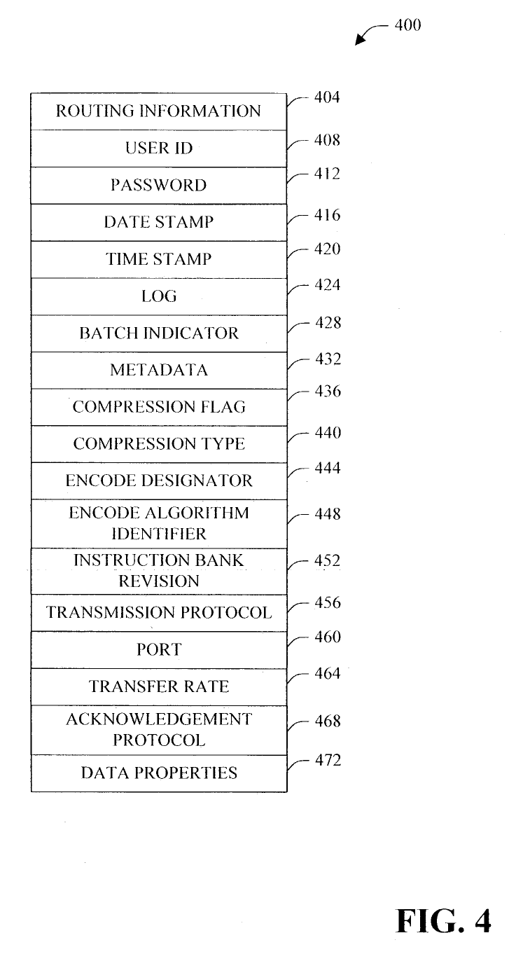

Proceeding to FIG. 4, an exemplary run ticket header 400 in accordance with an aspect of the present invention is illustrated. The header 400 includes exemplary information that can be bound to an item (e.g., transformed input). The header 400 includes routing information 404, a user ID 408, a password 412, a date stamp 416, a time stamp 420, a log 424, a batch indicator 428, meta data 432, a compression flag 436, a compression type 440, an encode designator 444, an encode algorithm identifier 448, an instruction bank revision label 452, a transmission protocol 456, a port 460, a transfer rate 464, an acknowledgment protocol 468, and data properties 472. It is to be appreciated that additional and/or different information can be employed, and that the header 400 provides examples of suitable information and is not intended to limit information which can be stored in a run ticket header.

The routing information 404 can be employed in a run ticket to create a self-routing input, which mitigate having to hard code routing parameters, as described above. The routing information can include delivery and/or return addresses (e.g., IP address(es), machine address(es) and/or machine alias(es)), for example.

The user ID 408 and/or the password 412 can be employed to access a component(s). Generally, a component(s) (e.g., an application, a line-of-business application, an internal business application and/or an order management system) receiving the run ticket can employ a mechanism to facilitate security, wherein a user ID and a password provides access to the component(s). The user ID 408 and the password 412 can be employed to provide the user ID and the password.

The date stamp 416 and the time stamp 420 can provide a mechanism to mark event(s) such as input arrival, transformation commencement and completion, transformed input conveyance and reception, encapsulation commencement and completion, including designation for individual information included in the run ticket, and run ticket transmission. In addition, the date stamp 416 and the time stamp 420 can be employed for further processing (e.g., algorithm(s) selected based on when certain event(s) occurred), accessed by other component(s) receiving the run ticket and/or utilized for archiving, for example.

The log 424 can provide detailed information, for example, an instruction-by-instruction account, commencing with the reception of the input through the transmission of the run ticket. For example, the log 424 can list the transformation algorithm name, and the results after individual step(s) of the algorithm. In addition, a path, or location, to the individual step can be included. Furthermore, error(s) and/or warning, including descriptive text, can be included. The foregoing provides processing information that can be utilized for auditing, debugging, testing, verification, validation, and/or assessing risk, for example.

The batch indicator 428 can be utilized to toggle between a batch mode wherein more than one input can be associated with and/or encapsulated in a run ticket (e.g., out bound batching, or OBB) and an individual mode wherein an input can be encapsulated within a run ticket. For example, more than one input and respective associated information (e.g., instructions and configuration) can be included in the run ticket.

Metadata 432 can include instructions and/or actions that can be encapsulated and transmitted with the run ticket. Metadata 432 can be utilized by network access adapter(s) such as an Electronic Data Interchange (EDI) Value-Added Network (VAN) adapter and a Society for Worldwide Interbank Financial Telecommunication (SWIFT) Net Link adapter, for example.

The compression flag 436 can be utilized to toggle whether compression should be employed. Data compression can be employed to improve transmission performance via reducing the number of bits to transfer. Various lossy and lossless technique(s) can be employed in accordance with an aspect of the present invention. The compression type 440 can be employed to identify one or more technique that can be utilized.

The encode designator 444 can be utilized to determine whether to employ encoding, for example whether to convert the information in to a series of 7-bit ASCII characters that can be transmitted via the Internet. The encode algorithm identifier 448 can provide the algorithm to employ. For example, the encode algorithm identifier 448 can denote uuencode and/or BinHex algorithms, for example

The instruction bank revision 452 can be utilized to provide a historical reference to an instruction bank. For example, as noted supra, a dynamic instruction bank can be employed, wherein information for an input can be added, modified and/or deleted. The instruction bank revision 452 provides a technique to associate a revision with the transmission of a run ticket.

The transmission protocol 456, the port 460, and the transfer rate 464 can be included to facilitate transmission. For example, where various protocols, ports and rates can be employed, the transmission protocol 456, the port 460, and the transfer rate 464 can provide suitable options. It is to be appreciated that a default protocol, port and transmission rate can additionally be employed.

The acknowledgment protocol 468 provides a mechanism to verify run ticket transmission. For example, techniques employing ACK/NAK can be utilized to indicate successful/unsuccessful transmission of the run ticket. As noted supra, various responses can be employed when the transmission is unsuccessful. For example, an error message can be transmitted, re-transmission can be employed, and/or an attempt can be made to resolve the problem, for example.

The data properties 472 can be employed to provide additional information regarding the input to the component receiving the run ticket. For example, the data properties can provide information related to subsequent processing and/or the un-translated input.

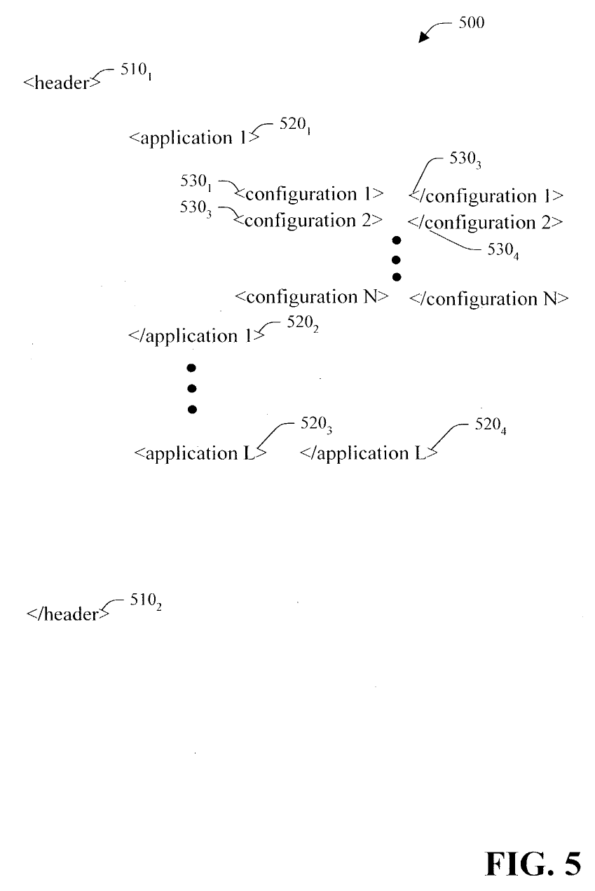

Referring next to FIG. 5, exemplary run ticket XML-based pseudo code 500 in accordance with an aspect of the present invention is illustrated. The run ticket 500 comprises a header fields 510₁, 510₂, application fields 520₁, 520₂, 520₃, 520₄, configuration fields 530₁, 530₂, 530₃, 530₄, 530₅, 530₆.

As noted supra, self-routing transformed input can be bound with associated information via(an envelope (e.g., an XML-based file) to embed processing rule(s) and/or configuration data (e.g., routing and/or other information) with transformed input to create a run ticket. The pseudo code 500 described herein illustrates exemplary XML-based pseudo code that can be employed within a run ticket to bind the associated information.

The header fields 510₁, 510₂ can be employed to designate the beginning and the ending, respectively, of the configuration. The application fields 520₁, 520₂ can be included within the header fields 510 to delineate at least a portion of the configuration to application(s). For example, configuration fields 530₁, 530₂, 530₃, 530₄, 530₅, 530₆ can be included to delineate configuration associated with “application one” (application fields 520₁, 520₂). Configuration for an application can further be delineated within the application fields 520. For example, configuration can be included serially and/or in various combinations within “application one.” For example, individual configuration can be included within one or more corresponding configuration fields 530. In another example, configuration information can be combined and included in one or more of the configuration fields 530.

The information within the foregoing exemplary pseudo code 500 can be accessible to a component that can transmit a run ticket, a component(s) that can receive the run ticket and/or an intermediate component(s) that can facilitate interaction between the run ticket transmitting and receiving components. For example, the dispatch component 240 can access the header to obtain application routing information to determine which application(s) should receive the run ticket. In another example, an adapter associated with the application receiving the run ticket can access the user ID and/or password in order to access the application. In yet another example, the application can access the information included in the header to obtain the associated configuration, and in addition, the application can extract the transformed input.

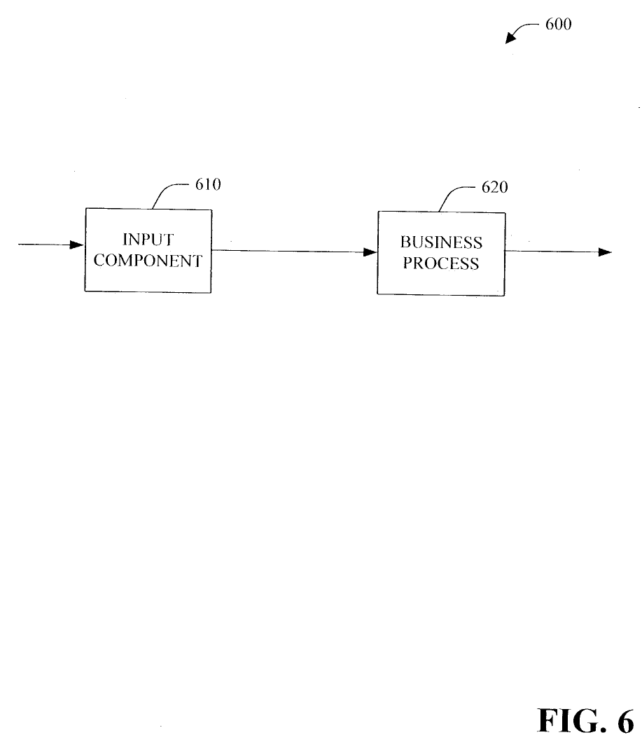

Next at FIG. 6, a batch interpreter system 600 in accordance with an aspect of the present invention is illustrated. The batch interpreter system 600 comprises an input component 610 to receive input and/or a run ticket(s), and a send adapter 620 to process batch configuration information for the run ticket(s).

The input component 610 can construct and transmit run tickets, receive and transmit run tickets, and/or receive and transmit input. For example, the input component 610 can receive an input (e.g., as described supra). Then, the input component 610 can translate the input, and bind the translated input with associated information to form a run ticket. Subsequently, the input component 610 can transmit the run ticket to the send adapter 620.

In another aspect of the present invention, the input component 610 can receive a run ticket(s). The input component 610 can then convey the run ticket to the send adapter 620. In yet another aspect of the present invention, the input component 610 can construct and/or receive a run ticket, as described above, and/or convey the input to the send adapter 620.

It is to be appreciated that a run ticket can be associated with more than one input to form a batch run ticket. For example, the run ticket can include more than one input and respective associated information. In one aspect of the present inventions the batch indicator 428, described above, and/or other mechanism can be employed to denote that an input is associated with a batch transmission technique. After receiving the input to be batched, the run ticket can be constructed to include the batched input and the associated information. In another aspect of the present invention, the run ticket can be constructed as the input to be batched arrives. The run ticket can be held until it encapsulates the input to be batched and the associated information. Then the run ticket can be transmitted. In another example, a batch run ticket can include an input and associated information, and information for one or more other inputs. In yet another example, a batch run ticket can include an input and associated information, and an indicator to notify a component that the run ticket (and/or input therein) is to be batch processed.

The send adapter 620 can receive input and/or a run ticket(s) from the input component 610, and subsequently transmit a run ticket(s). In one aspect of the present invention, the send adapter 610 can receive input to be batched. As noted above, the run ticket can be constructed as the batch input arrives and/or constructed when the batched input arrives. Various techniques can be employed to facilitate construction of a batch run ticket, for example temporary memory can be employed to store input prior to and during run ticket formation.

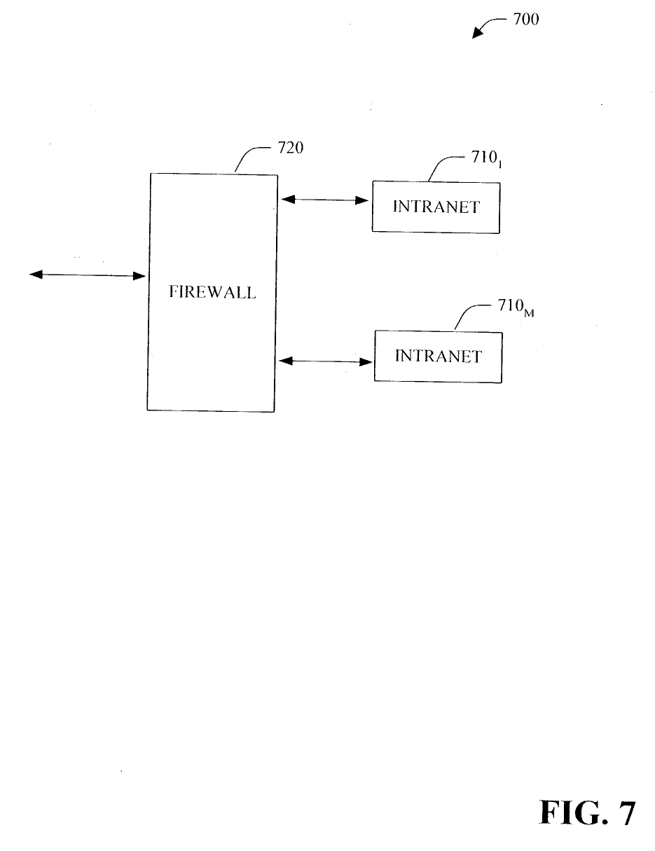

Turning to FIG. 7, a system 700 employing run ticket(s) in accordance with an aspect of the present invention is illustrated. The system 700 includes a first intranet 710₁ through an Mth intranet 710_{M}, where M is an integer greater than or equal to one. The first intranet 710₁ through the Mth intranet 710_{M} can be collectively referred to as the intranet(s) 710. The system 700 further includes an intranet firewall 720 to facilitate access to another intranet and/or the Internet.

The intranet(s) 710 can comprise a plurality of systems (e.g., components, computers and computer networks), wherein the plurality of systems can interact amongst another and communicate via the Internet. For example, in one aspect of the present invention, the intranet 710₁ can be employed to network a plurality of computers. The plurality of computers can share resources (e.g., applications and databases) and, if granted permission, access and utilize information stored on one or more of the plurality of computers. In addition, the plurality of computers can access the Internet and/or other intranets (e.g., the intranet 710_{M}) via the firewall 720. Moreover, the other intranets can access the intranet 710₁ and the associated plurality of computers via the firewall 720.

The intranets 710 can be employed with the systems described above. For example, the intranet 710₁ can employ a system 100 to construct and/or transmit a run ticket to another component associated with the intranet 710₁, to one or more of the intranet(s) 710 and/or the Internet.

For example, a component (e.g., an external trading partner) associated with the first intranet 710₁ can transmit a file (e.g., text, video and audio) to the system 100 to be delivered to another component (e.g., an internal business application and/or order management system) on a similar and/or different intranet, and/or the Internet. After receiving the file, the system 100 can translate the file into a suitable representation, and encapsulate the representation and associated information (obtained from a central information bank) into a self-routing envelope (e.g., run ticket). The system 100 can then transmit the run ticket to component(s) designated in the run ticket. For example, the system 100 can obtain routing information, and/or security information (e.g., a user ID and a password) from the run ticket in order to identify the receiving component(s).

The receiving component can utilize the information within the run ticket and/or transmit the information, at least part of the information and/or other information to the transmitting component and/or other components. The receiving component can similarly employ a system 100. For example, the receiving component can transmit a file to the system 100, wherein the system 100 can translate, bind and encapsulate the file and associated information. For example, the file can be transmitted to a component utilizing a secure communication protocol (e.g., a shared secret). The system 100 can obtain the shared secret, and bind the shared secret to the file via a run ticket. Then, the run ticket can transmit the run ticket to the component employing the secure communication protocol.

In another aspect of the invention, one or more of the intranets 710 can be further delineated into sub networks (e.g., domains and groups). Likewise, the sub networks can employ firewalls and/or other technique to facilitate transmitting data. For example, any computers of a sub network can share resources and interact amongst another, if granted permission. The computers can further share resources and interact with computers on another sub network, including sub networks residing on a different intranet. It is further to be appreciated that a hierarchy of networks (e.g., horizontal and/or vertical) can be cascaded, wherein a network (and a sub component thereof) can include individual administration, security and/or configuration that can be similar and/or different from another network.

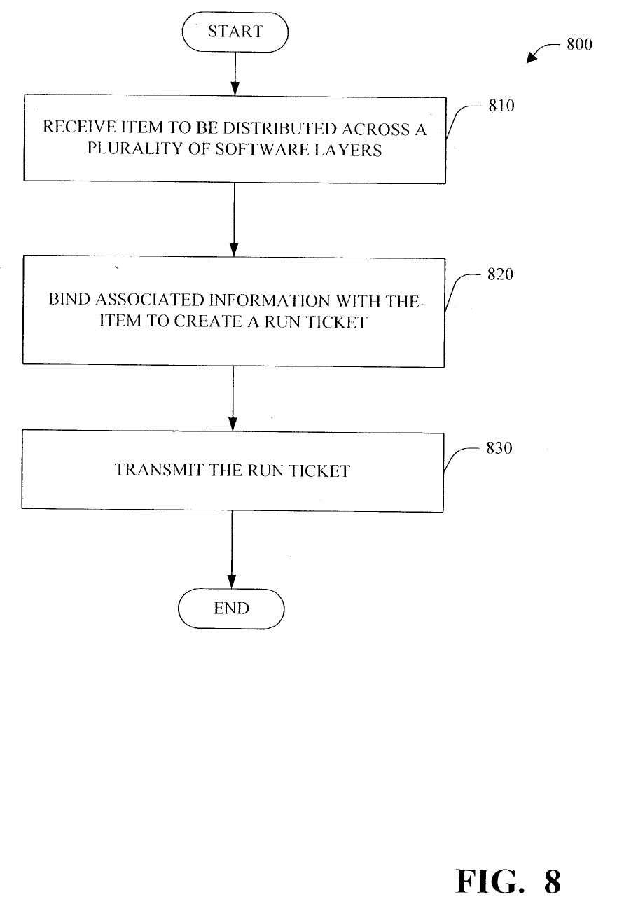

Turning to FIGS. 8, 9 and 10, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments. Moreover, the methodologies can be implemented within various environments including web servers, web services, intranets, internets and/or other distributed systems.

Turning to FIG. 8, a method of constructing a run ticket 800 in accordance with an aspect of the present invention is illustrated. At 810, an item to be distributed across a plurality of software layers is received. For example, the item can be a purchase order and/or an invoice in cXML, XML, postscript, Portable Document Format (PDF), Rich Text, and/or encoded file format.

At 820, associated information is bound with the item to create a run ticket. For example, the associated information can be stored in a processing rules data store 130, an instructions bank 230 and/or an information data store 340. At 830, the run ticket is transmitted (e.g., to an external trading partner).

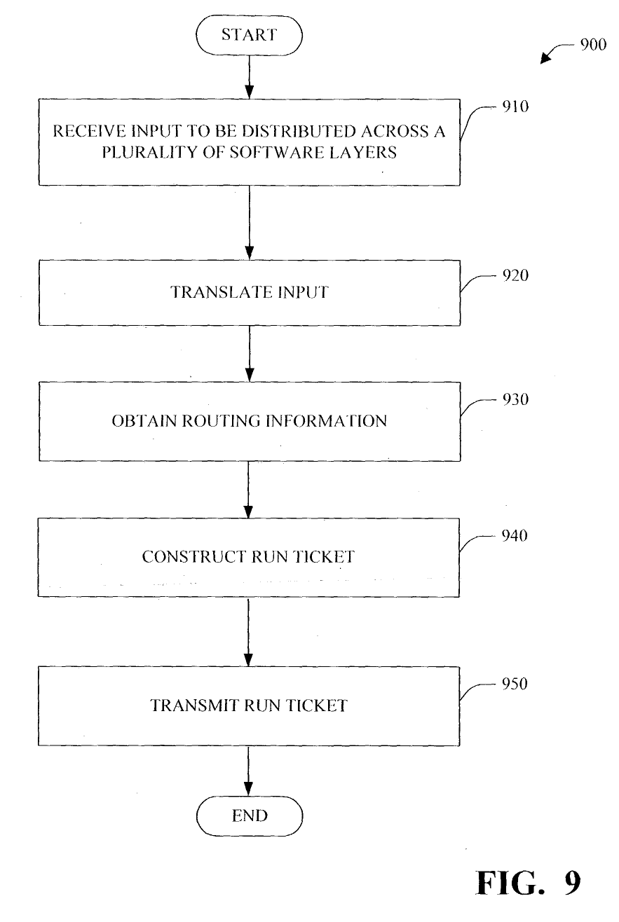

Next, referring to FIG. 9, a method to construct and employ a run ticket 900 in accordance with an aspect of the present invention. At 910, an input is received, for example, from a component such as a trading party (e.g., a purchase order and/or an invoice in XML, cXML postscript, Portable Document Format (PDF), Rich Text, and/or encoded file format, and/or any of the various input described supra) to be transmitted to one or more components residing across a distributed network.

After being received, the input can be translated at 920 to a suitable format. For example, the input can be translated into a markup language representation. Typical business transactions can be translated to a cXML file. In addition to translating the input, the original input and/or the translated input can be stored. The stored input and/or translated input can be employed as an archive, for debugging translation algorithms, for a subsequent transmission when the prior transmission failed, and/or a log, for example.

At 930, routing information is obtained from a storage medium (e.g., from a processing rules data store 130, an instructions bank 230 and/or an information data store 340). The storage medium is generally employed as a common storage area for information associated with any and/or substantially all input. Conventional systems typically utilize a plurality of storage media, which can increase overhead due to increased maintenance associated with maintaining the storage media. Thus, the present invention mitigates the cost associated with maintaining a storage medium for individual components associated information.

In addition, conventional systems typically hard code information such as routing information. The present invention mitigates having to hard code the routing information via providing the routing information in the storage medium where it can be accessed and bound to the input in a run ticket. Moreover, the storage medium can be dynamic to increase system flexibility. A dynamic storage medium provides for adding, modifying and/or deleting, and subsequent refreshing information without affecting the other components employed in the methodology.

After obtaining the routing information from the storage medium, a run ticket is constructed at 940. For example, the run ticket can be an XML-based File that includes the translated input (e.g., XML-based) and the associated information (e.g., routing information) from the storage medium. The associated information is typically included as header information, and can provide information for the component(s) receiving the run ticket. However it is to be appreciated that other techniques can be employed.

At 950, the run ticket is transmitted. The routing information encapsulated in the run ticket can be employed to route the run ticket to appropriate component(s) and/or system(s). The receiving component(s) can then employ the input and/or the associated information.

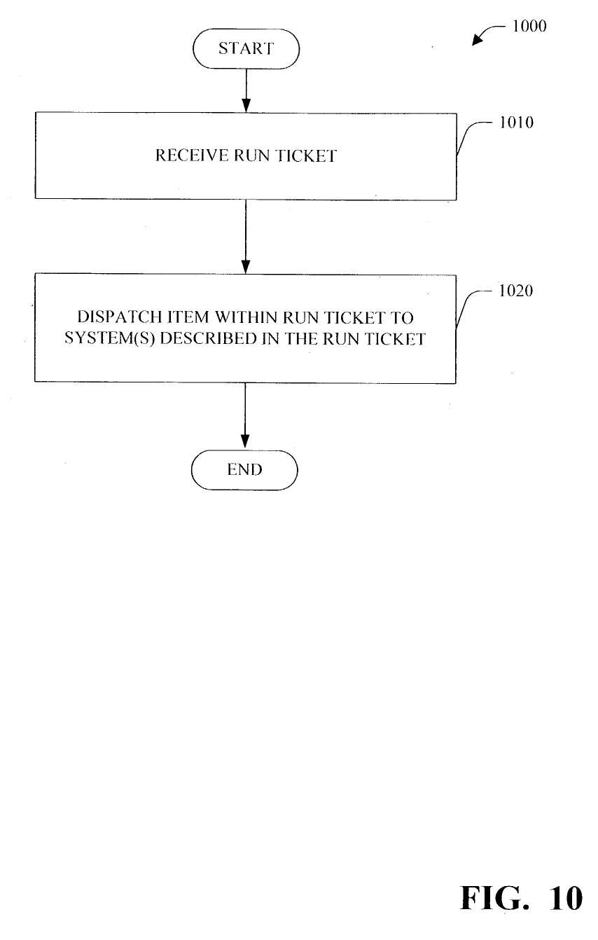

Referring to FIG. 10, a method of utilizing a run ticket 1000 in accordance with an aspect of the present invention is illustrated. At 1010, a run ticket is received. At 1020, an item embedded within the run ticket is dispatched to system(s) described in the run ticket.

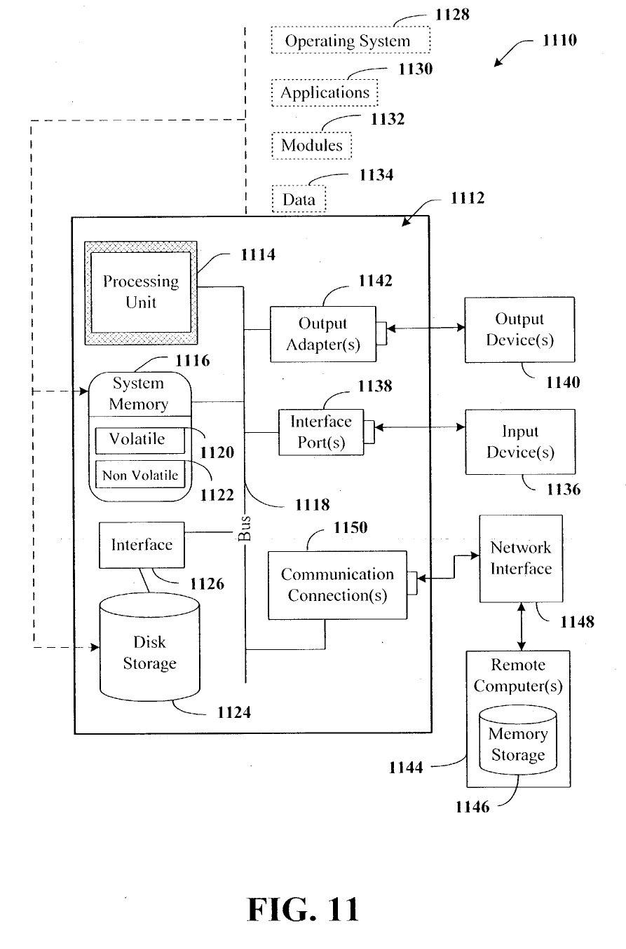

In order to provide additional context for various aspects of the present invention, FIG. 11 and the following discussion are intended to provide a brief, general description of a suitable operating environment 1110 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1110 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 11 an exemplary environment 1110 for implementing various aspects of the invention includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/nonremovable, volatile/nonvolatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the present invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates distributed processing associated with a plurality of systems in connection with an item, comprising:
an input component that receives an item that is to be distributed across a plurality of software layers; and,
a binding component that annotates the item with a run ticket to facilitate preserving integrity of the distributed processing rules as the item flows through the software layers.

2. The system of claim 1, annotation of the binding component being based, at least in part upon information received from a processing rules data store.

3. The system of claim 2, further comprising the processing rules data store.

4. The system of claim 1, the run ticket comprising at least one of an XML document and metadata.

5. The system of claim 1, the item comprising a markup language document.

6. The system of claim 5, the markup language being at least one of XML, cXML, HTML, XHTML, and DAML.

7. The system of claim 1, the run ticket comprising self-routing information associated with the item.

8. The system of claim 1, employed in at least one of an e-commerce and an e-business environment.

9. A system to facilitate business transactions, comprising:
a translation component to convert input;
an instructions bank to store information associated with the input; and
an encapsulation component operatively coupled to the translation component and the instructions bank, wherein the encapsulation component obtains the converted input from the translation component and associated information from the instructions bank, and constructs a run ticket comprising the converted input and associated information.

10. The system of claim 9, the input comprising at least one of a document, a file, analog video, digital video, analog audio, digital audio, optical data, a spreadsheet, a response, a binary file, a still image, a word processing file, a jpeg file, a bitmap file, a tiff file, a gif file, a cgm file, an emf file, a sound file, an MSV file, an MP3 file, a digital moving image, an mpeg file, an AVI file, a facsimile, an email, a satellite signal, an encrypted file, an encoded file, a compressed file and symbolic information.

11. The system of claim 9, the translation component further receiving input from a business party.

12. The system of claim 9, the converted input comprising a markup language.

13. The system of claim 12, the markup language being at least one of XML, cXML, HTML, XHTML and DAML.

14. The system of claim 9, the converted input comprising one of substantially all of the input and a portion of the input.

15. The system of claim 9, the encapsulation component binding the converted input and the associated information to form the run ticket.

16. The system of claim 9, wherein the encapsulation component further provides the run ticket to a dispatch component.

17. The system of claim 9, the encapsulation component employing a mechanism to check for an error associated with at least one of the converted input and the associated information.

18. The system of claim 17, the error checking mechanism providing at least one of rejecting erroneous data, transmitting an error message, attempting to resolve the error, and halting the binding of the converted input and associated information.

19. The system of claim 9, the run ticket comprising an XML-based envelope.

20. The system of claim 9, the associated information stored in a header of the run ticket.

21. The system of claim 9, the associated information comprising at least one of routing information, a user ID, a password, a date stamp, a time stamp, a log, a batch indicator, meta data, a compression flag, a compression type, an encode designator, an encode algorithm name, an instruction bank revision label, a transmission protocol, a port, a transfer rate, an acknowledgment protocol and data properties.

22. The system of claim 9, the run ticket comprising a self-routing unit.

23. The system of claim 9, further comprising a dispatch component to transmit the run ticket.

24. The system of claim 23, wherein the dispatch component accesses the run ticket to route the run ticket.

25. The system of claim 9, employed in at least one of a web server, a web service and an integration engine.

26. The system of claim 9, employed in at least one of an e-commerce, an e-business environment and a distributed network.

27. The system of claim 9, the run ticket comprising meta data utilized to interface with a network access adapter, wherein the network access adapter comprises an Electronic Data Interchange (EDI) Value-Added Network (VAN) adapter and a Society for Worldwide Interbank Financial Telecommunication (SWIFT) Net link adapter.

28. A run ticket header schema, comprising:
a first header field to denote the beginning of configuration information;
a second header field to denote the ending of configuration information;
a plurality of applications fields to delineate the configuration information within the first header field and the second header field; and
a plurality of configuration fields to delineate the configuration information amongst the plurality of applications fields.

29. The schema of claim 28, based on an XML schema.

30. The schema of claim 28., the configuration fields employed to store associated information comprising at least one of routing information, a user ID, a password, a date stamp, a time stamp, a log, a batch indicator, meta data, a compression flag, a compression type, an encode designator, an encode algorithm name, an instruction bank revision label, a transmission protocol, a port, a transfer rate, an acknowledgment protocol and data properties.

31. A method of constructing a run ticket comprising:
receiving an item to be distributed across a plurality of software layers;
binding associated information with the item to create a run ticket; and,
transmitting the run ticket.

32. The method of claim 31, the item comprising at least one of a purchase order, an invoice, a postscript file, a Portable Document Format file a Rich Text file, an encoded
tile, a document, analog video, digital video, analog audio, digital audio, optical data, a spreadsheet, a responses, a binary file, a still image, a word processing files, a jpeg file, a bitmap, a tiff file, a gif file a cgm file, an emf file sound, a MSV file, a MP3 file, a digital moving image, a mpeg file, an AVI file, a facsimile, an email, a satellite signal, an encrypted file, a compressed files and symbolic information.

33. A method to construct and employ a run ticket comprising:
receiving an input to be distributed across a plurality of software layers;
obtaining routing information; and,
constructing a run ticket.

34. The method of claim 33 further comprising at least one of the following acts:
translating the input; and,
transmitting the run ticket.

35. A method of utilizing a run ticket comprising:
receiving a run ticket; and,
dispatching an item within the run ticket to a system described in the run ticket.

36. A data packet transmitted between two or more computer components that facilitate business transactions between business parties comprising:
at least one data field comprising an item and associated information, the associated information comprising at least one of configuration data, instructions and processing rules.

37. A computer readable medium storing computer executable components for a system comprising:
an input component that receives an item that is to be distributed across a plurality of software layers; and,
a binding component that annotates the item with a run ticket to facilitate preserving integrity of distributed processing rules as the item flows through the software layers.

38. A system that facilitates distributed processing associated with a plurality of systems in connection with an item, comprising:
means for receiving an item that is to be distributed across a plurality of software layers; and,
means for annotating the item with data that facilitates preserving integrity of the distributed processing rules as the item flows through the software layers.
